(19) United States
(12) Patent Application Publication
(10) Pub. No.: US 2023/0370241 A1
(43) Pub. Date: Nov. 16, 2023

(54) TIME SYNCHRONIZATION TECHNOLOGIES

(71) Applicant: Intel Corporation, Santa Clara, CA (US)

(72) Inventors: Daniel Christian BIEDERMAN, Saratoga, CA (US); Mark BORDOGNA, Andover, MA (US); Christopher S. HALL, Portland, OR (US); James COLEMAN, Mesa, AZ (US)

(21) Appl. No.: 18/206,027

(22) Filed: Jun. 5, 2023

(51) Int. Cl. H04L 7/00

(52) U.S. Cl. CPC H04L 7/0008; H04L 7/0087

(57) ABSTRACT

Examples described herein relate to a in a group of servers: the servers attempting to perform timing synchronization based on a first group of timing signals sent via a first path. In some examples, the first comprises a first connection and based on disruption of communications by the first connection between servers in the group of servers. In some examples, the servers attempting to perform timing synchronization based on a second group of timing signals sent via a second path. In some examples, the second path does not traverse the first connection.

### BACKGROUND

In distributed computing systems (e.g., data center, data center MegaPOD, a rack of servers, a server, or others), operations are performed according to independent clock signals and independent time domains. Time synchronization is used to attempt to synchronize time stamps in different time domains. However, where different devices utilize clock signals that are not synchronized with a reference clock signal, uncertainty in clock frequency and clock signal transitions can arise. Clock uncertainty can impact performance of applications in distributed computing systems and increase time to workload completion.

### BRIEF DESCRIPTION OF THE DRAWINGS

FIG. 1A depicts an example operation.

FIG. 1B depicts an example mode of operation.

FIG. 2A shows an example system.

FIG. 2B depicts an example system.

FIGS. 2C-1 to 2C-3 depict examples time stamp capture for edges of a control signal.

FIGS. 3A-3C depict examples of interface pins and example operations.

FIG. 4 depicts an example system.

FIG. 5A depicts an example of generation of timing signals using a circuitry configured to perform a state machine.

FIG. 5B depicts an example output system.

FIG. 6A depicts an example of microcontroller that communicates with CPU clusters.

FIG. 6B depicts a processor to execute instructions to control a value output from the input-output circuitry based on counter values.

FIG. 7 depicts an example of instruction execution to sample an I/O.

FIG. 8 depicts an example process.

FIG. 9 depicts an example system.

FIG. 10 depicts an example system.

### DETAILED DESCRIPTION

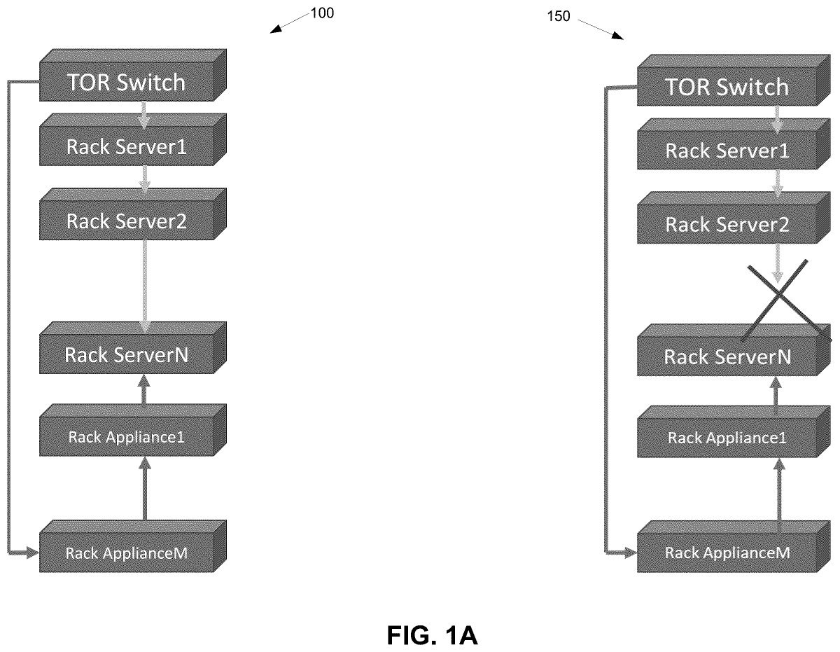

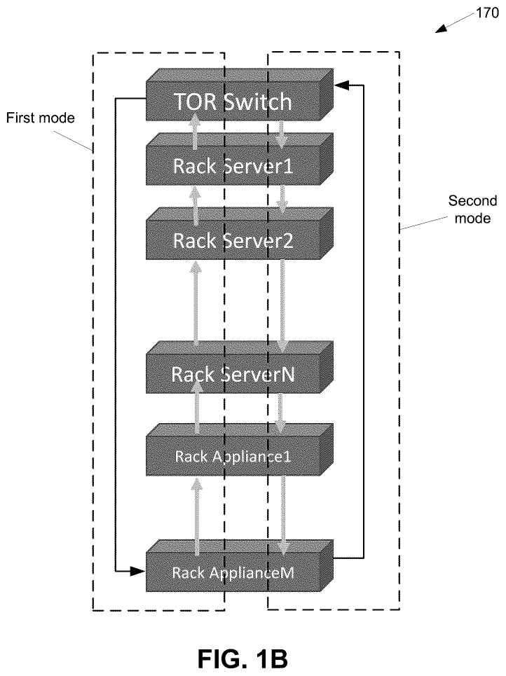

FIG. 1A depicts an example scenario 100 where multiple servers synchronize timing signals based on a clock signal generated by a network interface device such as a top of rack (TOR) switch. In scenario 100, TOR switch could send timing signals, namely a pulse per second (PPS) or a clock (10 KHz, 10 MHz, etc.) to one or more of rack servers 1 to N and appliances 1 to M, where N and M are integers and a value of 2 or more. The rack servers and appliances can send timing signals in clockwise or counter-clockwise directions to communicate timing information based on IEEE1588-2019 or Peripheral Component Interconnect express (PCIe) precision time measurement (PTM) as a first method and/or the PPS or clock as a secondary method. Rack servers and appliances can synchronize their clock signals based on the first or second methods.

In scenario 100, rack server 1 receives a timing signal from a TOR switch, rack server 2 receives a timing signal from rack server 1, and so forth. Rack server 1, server 2, server N, rack appliance 1, and rack appliance M, synchronize clock signals based on received timing signals. In other words, TOR switch can perform clock synchronization to attempt to synchronize with server 1, server 2 can perform clock synchronization to attempt to synchronize with server 1, and so forth. Scenario 100 can be used in a data center rack where a TOR switch communicates data via a medium (e.g., Ethernet). Data could include timing packets, such as those used in IEEE1588-2019, or timing signals based on Peripheral Component Interconnect express (PCIe) precision time measurement (PTM).

However, if connectivity between the TOR switch, rack servers, or rack appliances is disrupted, clock synchronization may be disrupted. For example, scenario 150 shows a disruption of connection between rack server 2 and rack server N because rack server 2 was powered down, cabling between rack server 2 and server N was removed, or there is a problem with the synchronization signals. In scenario 150, rack server N can potentially not be able to synchronize its clock signal with the clock signal from TOR switch and operations performed by rack server N may be out of synchronization with timing signals of the TOR switch.

Various examples described herein can attempt to provide timing signals to servers or appliances from a time source despite disruption in connectivity between the time source and one or more servers or between a server and appliance. In some examples, the time source includes a switch or other network interface device. In some examples, the time source can generate timing signals based on a timing protocol. The timing protocol can be based on one or more of: Institute of Electrical and Electronics Engineers (IEEE) 1588, Peripheral Component Interconnect express (PCIe) precision time measurement (PTM), or other wired or wireless protocols. Timing signals can include a pulse per second (PPS), a timing clock (10 KHz, 10 MHz, etc.), or other patterns.

In some examples, a primary manner of synchronizing time of a device or chiplet utilizes one or more of: IEEE1588, Network Time Protocol (NTP), PTM, or others. Devices or chiplets can adjust time of elements in a system to be within a certain tolerance. In some examples, ring or point-to-point connections among devices or chiplets can provide secondary or redundant technology for communicating time.

For example, the time source and servers can communicate timing signals using bi-directional interfaces. The bi-directional interface can include an egress interface and an ingress interface. Via a bi-directional interface, network interface device and servers or appliances can communicate pulse signals from a time source either via a first mode path of connections between servers in the group of servers or based on disruption of communications in the first connection between servers in the group of servers, via a second mode path that does not traverse the first connection. For example, FIG. 1B depicts an example of providing first and second modes of communications between a time source (e.g., switch) and server, server-to-server, and server-to-appliance. Accordingly, based on loss of connectivity between a server and the time source (e.g., server is in sleep state or inoperative), timing pulse signals can be provided to a server or device via a second path to synchronize a clock signal based on timing pulse signals from the time source.

Some examples can provide for communication of time pulse signals via systems (e.g., network interface device, servers, or appliances) using bi-directional interfaces. In a first mode, systems can propagate timing signals in a first direction (e.g., counter-clockwise). Based on disruption of communication of timing signals in the first direction between at least two systems, the second mode can be performed where systems propagate timing signals in a second direction (e.g., clockwise or opposite that of the first direction).

In some examples, to change between a connection from first mode of operation to second mode of operation or vice versa, the bi-directional interface in a TOR switch, rack server, or rack appliance can be changed by changing an input to an output and changing an output to an input. For example, the bi-directional interface can include a time-aware general-purpose input output (TGPIO). For example, to change a pin from output to input, the TGPIO output could be reconfigured to output to high-Z. Likewise, to change a pin from input to output, the TGPIO input pin could enable the path to capture the time on the detection of a rising edge and be reconfigured to disable the input circuitry and enable the output circuitry to output pulses at precise times, entering a tristate mode to communicate in multiple directions. Bi-directional interfaces can be implemented as multiple TGPIO pins or hardware assist logic or circuitry.

In some examples, the bi-directional interface can be implemented using a TGPIO that includes circuitry to create a timing pattern output based on execution of instructions. For example, the circuitry can include a microcontroller or circuitry configured to implement a state machine to generate the timing pattern output. In some examples, a microcontroller can execute an instruction to generate to the timing pattern output by specifying one or more of: a particular time to output a particular value or an amount of time to wait for a precise time to output a particular value. For example, an instruction could be of a format such as: “MOVE A B T,” where the command moves the value from Register A to Register B at or after time T. Note that in some cases, Register B could be a register controlling an output from an IO pin.

A general purpose IO is an example of an interface. However, other interfaces can be used such as data buses (e.g., multiple IOs) or other circuitry. For example, a pin can be utilized to generate a Pulse Per Second (PPS) to communicate a timing pulse to another device. For example, a clock pin can be used to generate clock edges in a repeated pattern. For example, a timing bus can be utilized to communicates time at a specific time.

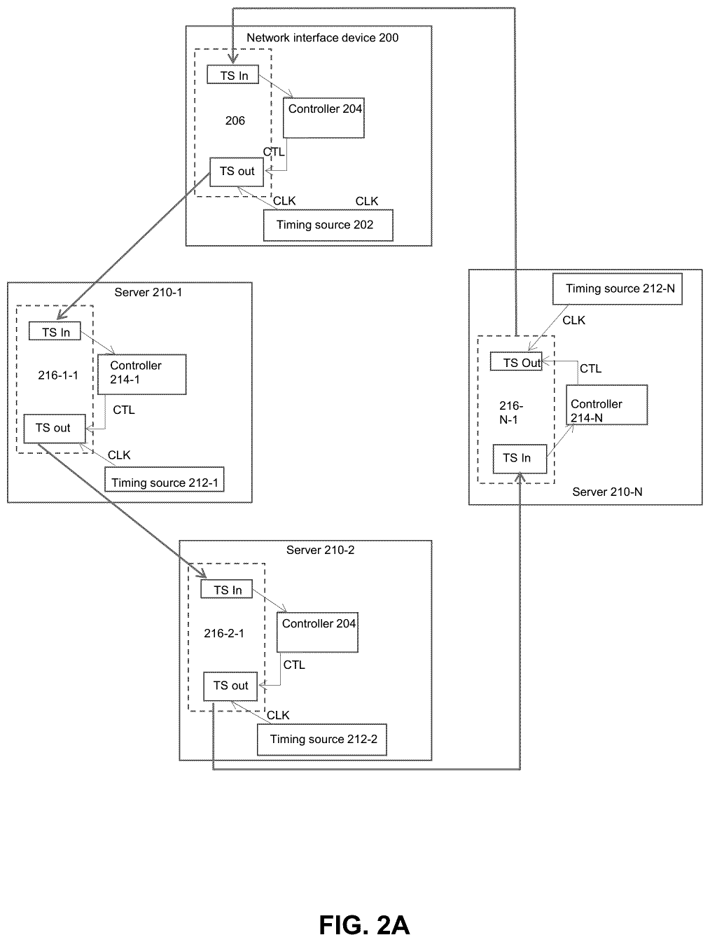

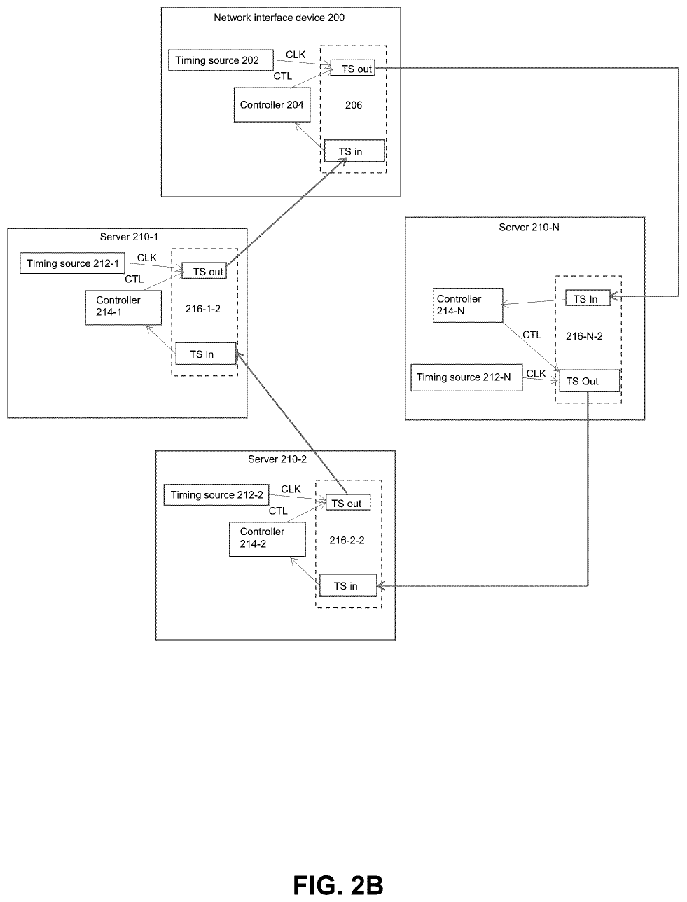

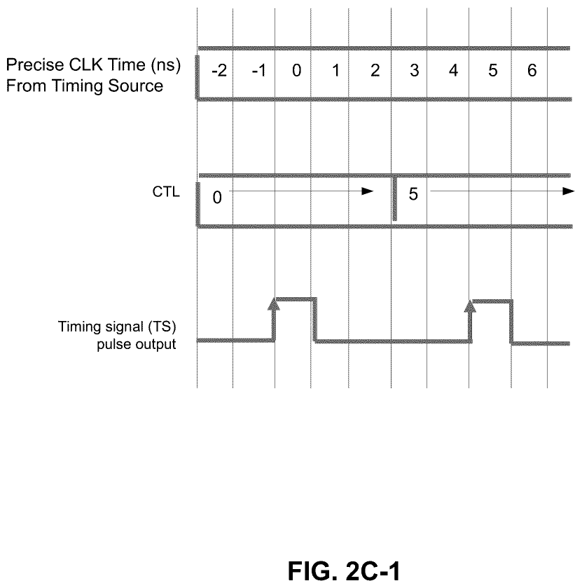

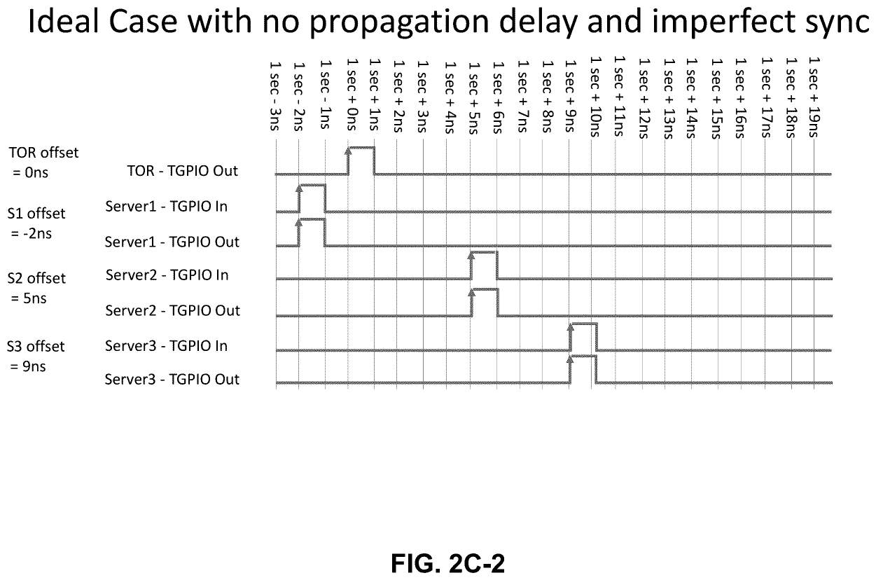

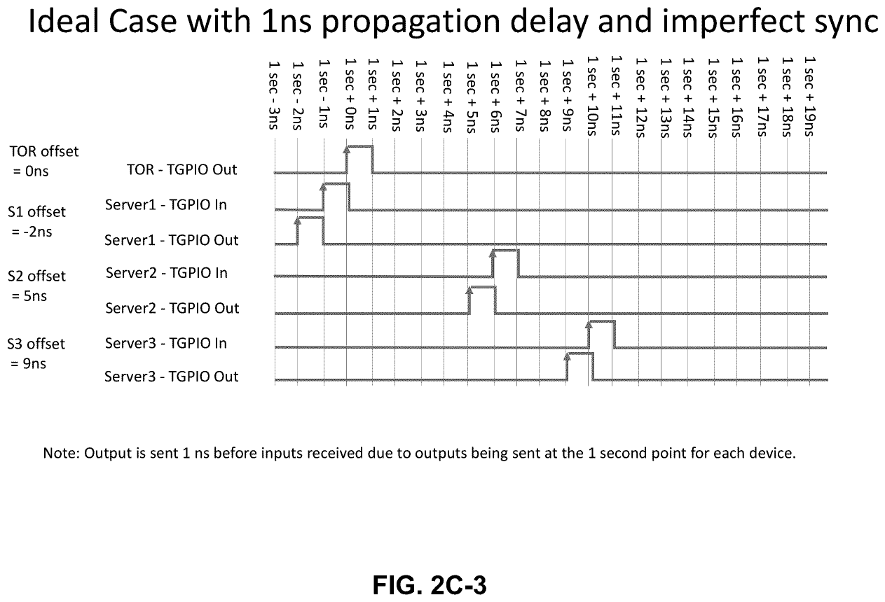

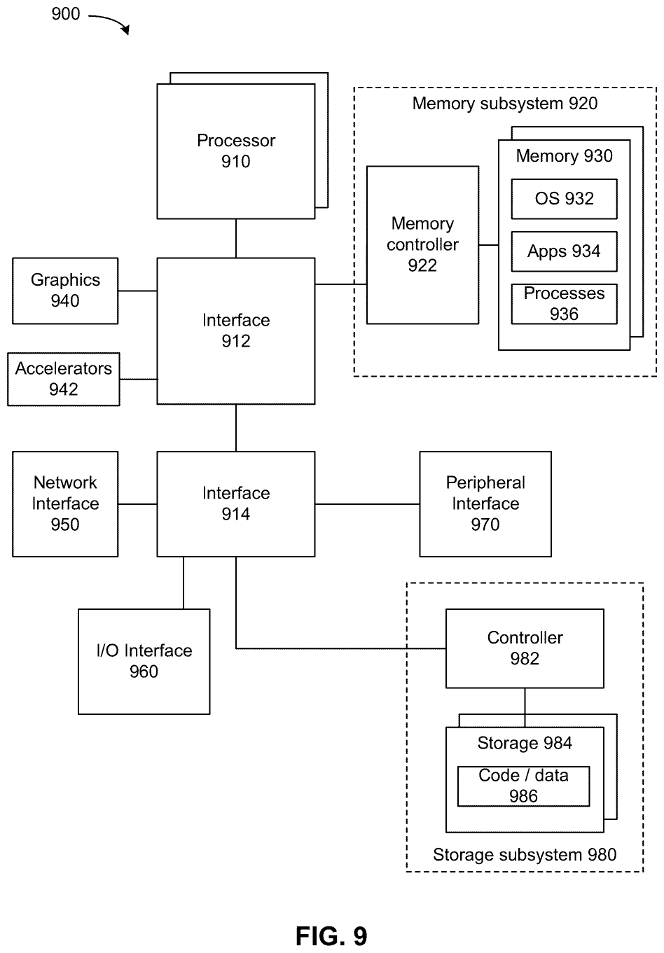

FIG. 2A shows an example system. In some examples, server systems 210-1 to 210-N (N is an integer and N≥2) and network interface device 200 can include various devices. Various devices can include one or more: central processing units (CPUs), xPUs, graphics processing units (GPUs), accelerators, memory devices, storage devices, memory controllers, storage controllers, network interfaces, and so forth. Server 210-1, server 210-2, and server 210-N can include a server, storage node with one or more storage devices, accelerator pool with one or more accelerator devices, memory pool with one or more memory devices, and so forth. In some examples, server systems 210-1 to 210-N and network interface device 200 can include components described with respect to FIGS. 9 and/or 10. Server systems 210-1 to 210-N can include circuitry and execute one or more services as well as other software described at least with respect to FIGS. 9 and/or 10. Various examples of a service include one or more of: a distributed database, distributed application, microservices application, distributed artificial intelligence (AI)/machine learning (ML) program, an application that is fully executed on one or more accelerators, an application that is partially executed on one or more accelerators, an application executed within a rack, at least part of the application is executed on a different rack, at least part of the application is in a different spine, at least part of the application is in a different data center, at least part of the application is in a different country, or at least part of the application is in a different continent.

In some examples, network interface device 200 can be implemented as one or more of: an infrastructure processing unit (IPU), data processing unit (DPU), smartNIC, forwarding element, router, switch, network interface controller, network-attached appliance (e.g., storage, memory, accelerator, processors, and/or security), and so forth. For example, network interface device 200 can provide a network interface for communications to and from at least one host system and for communications to and from at least one server system. Network interface device 200 and server systems 210-1 to 210-N can be communicatively connected using a host or device interface (e.g., Peripheral Component Interconnect express (PCIe), Universal Chiplet Interconnect Express (UCIe), Compute Express Link (CXL), or others) or network protocols, described herein. In some examples, network interface device 200 and server systems 210-1 to 210-N can be communicatively connected as part of a system on chip (SoC) or integrated circuit.

Network interface device 200 can utilize timing source circuitry 202 that is to generate a clock signal (CLK) based on one or more of: a global positioning system (GPS) signal, stratum clock, clock source, or others), Network Time Protocol (NTP), Precision Time Protocol (PTP) timestamps (e.g., IEEE1588-2019), wireless synchronization (e.g., Ultra-Wideband (UWB) IEEE802.15.4-2011 or IEEE 802.15.4z-2020), Peripheral Component Interconnect express (PCIe) PTM, Network Time Protocol (NTP) (e.g., RFC 5905 (2010), Synchronous Ethernet (SYNC-E) (e.g., International Telecommunication Union (ITU) recommendations G.8261, G.8262, and G.8264), or others. In some examples, an oscillator can provide a reference clock signal CLK and the oscillator can be on-die or off-die from network interface device 200.

Network interface device 200 can include controller circuitry 204 that is to generate a control signal (CTL) to cause bi-directional interface 206 to generate a timing signal (TS) output with one or more pulses at particular time stamp values based on CLK from timing source 202. Timing signal TS can include a 1 pulse per second (1PPS) signal, 10 KHz signal, 10 MHz signal, or other frequency of signal. Note that reference to bi-directional interface can refer to an interface with multiple inputs and multiple outputs so that based on disruption of communications of timing signals through one of the outputs, communications of timing signals can be made through another of the outputs. Note that communications of data or timing signals between devices can be made using wired or wireless signals, including waveguides.

Server 210-1 can include controller circuitry 214-1 that is to generate a CTL signal to cause bi-directional interface 216-1-1 to generate a timing signal TS output based on particular time stamp values based on signal CLK from timing source 212-1. Timing signal TS can include a 1PPS signal, 10 KHz signal, 10 MHz signal, or other frequency of signal. Similarly, server 210-2 can include controller circuitry 214-2 that is to generate a CTL signal to cause bi-directional interface 216-2-1 to generate a timing signal TS output based on particular time stamp values based on CLK from timing source 212-2. Timing signal TS can include a 1PPS signal, 10 KHz signal, 10 MHz signal, or other frequency of signal. Similarly, server 210-N can include controller circuitry 214-N that is to generate a CTL signal to cause bi-directional interface 216-N−1 to generate a timing signal TS based on particular time stamp values based on CLK from timing source 212-N. Timing signal TS can include a 1PPS signal, 10 KHz signal, 10 MHz signal, or other frequency of signal.

In a first mode, network interface device 200 can provide 1 PPS signal or other timing signal generated based on timestamps relative to CLK at times specified by CTL to server 210-1 via bi-directional interface 206. Timing signals transmitted from network interface device 200 to server 210-1 can be used to align a clock signal CLK generated by timing source 212-1 of server 210-1 based on timing signals from network interface device 200. In the first mode, server 210-1 can attempt to correct or reduce offset of a clock signal generated by timing source 212-1 based on timing signal from network interface device 200. For example, to correct or reduce offset, server 210-1 can perform time domain translation based with interpolation variables (e.g., linear, quadratic, or beyond) between a 1 PPS signal or other timing signal generated by server 210-1 and 1 PPS signal or other timing signal received from network interface device 200. For example, an adjustment to the clock signal utilized by server 210-1 can be based on a linear relationship with a reference clock signal:

y=m*x+b, where

y represents a received 1 PPS signal or other timing signal from a network interface device 200,

x represents a 1 PPS signal or other timing signal generated by server 210-1,

m represents a linear coefficient, and

b represents an offset.

In the first mode, a CLK signal generated by timing source 212-1 and utilized by server 210-1 can be adjusted so that 1 PPS signal or other timing signal aligns with 1 PPS signal or other timing signal from network interface device 200 and potentially considering propagation delay. Similarly, in the first mode, a CLK signal utilized by server 210-2 can be adjusted so that 1 PPS signal or other timing signal aligns with 1 PPS signal or other timing signal from server 210-1 and potentially considering propagation delay. Similarly, in the first mode, a CLK signal utilized by server 210-N can be adjusted so that 1 PPS signal or other timing signal aligns with 1 PPS signal or other timing signal from server 210-2 and potentially considering propagation delay.

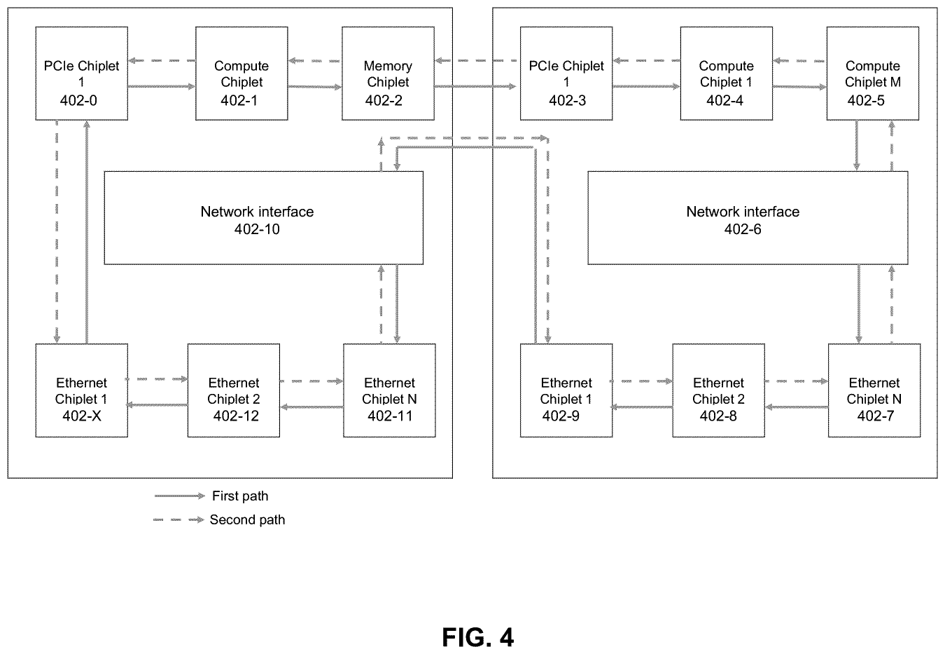

During the first mode, based on detection of a loss of connection between two or more systems (e.g., one or more of network interface device 200, server 210-1, server 210-2, or server 210-N), a system can change from the first mode to the second mode to change a path from which timing is received or transmitted to provide a redundant or second path for timing signals so that systems can synchronize timing signals. For example, network interface device 200 can communicate via a device interface or using a networking protocol with one or more of server 210-1 to 210-N and determine which of server 210-1 to 210-N is subject to a loss of connection based on not responding to messages from network interface device 200. Network interface device 200 can send request for response signals to servers 210-1 to 210-N and based on no response within a particular time window from one or more of servers 210-1 to 210-N, network interface device 200 can determine a connection to be broken, malfunctioning, or inoperative for a server from which no response was received. In this example, network interface device 200 can receive no response within a time window from server 210-2, network interface device 200 can determine that connection from server 210-1 to server 210-2 is inactive. A connection can be inoperable or unresponsive based on failure and or powered-down server die or system of chiplets (e.g., FIG. 4).

For example, where a connection between server 210-2 and server 210-1 is disrupted or otherwise determined to be inoperative, operation can change to a second mode. In the second mode, a second path can be utilized to synchronize timing signals. FIG. 2B depicts an example operation of the second mode. For example, network interface device 200 can adjust bi-directional interface 206 to operate in the second mode to generate and output a timing signal at particular time stamp values to server 210-N based on CLK from timing source 212-N and CTL signal from controller circuitry 214-N. A CLK signal utilized by server 210-N can be adjusted so that 1 PPS signal or other timing signal aligns with 1 PPS signal or other timing signal from server 210-N and potentially considering propagation delay.

For example, server 210-N can adjust bi-directional interface 216-N−2 to operate in the second mode to generate and output a timing signal at particular time stamp values to server 210-2 based on CLK from timing source 212-N and CTL signal from controller circuitry 214-N. A CLK signal utilized by server 210-2 can be adjusted so that 1 PPS signal or other timing signal aligns with 1 PPS signal or other timing signal from server 210-N and potentially considering propagation delay.

For example, server 210-2 can adjust bi-directional interface 216-2 to operate in the second mode (bi-directional interface 216-2-2) to generate and output a timing signal at particular time stamp values to server 210-1 based on CLK from timing source 212-2 and CTL signal from controller circuitry 214-2. A CLK signal utilized by server 210-1 can be adjusted so that 1 PPS signal or other timing signal aligns with 1 PPS signal or other timing signal from server 210-2 and potentially considering propagation delay.

For example, server 210-1 can adjust bi-directional interface 216-1 to operate in the second mode (bi-directional interface 216-1-2) to generate and output a timing signal at particular time stamp values to network interface device 200 based on CLK from timing source 212-1 and CTL signal from controller circuitry 214-1. A CLK signal utilized by network interface device 200 can be adjusted so that 1 PPS signal or other timing signal aligns with 1 PPS signal or other timing signal from server 210-1 and potentially considering propagation delay.

Please note that even though the number shows 1 to N or 1 to M, the actual sever or appliance number value could be based on placement. Servers and appliances can be connected so that the length of the connecting wires could be of same length. By connecting every other server/or appliance, on the return path, instead of a long wire, a similar length of wires can be achieved by connecting missed servers and appliances on a return route to the TOR switch.

Note that time synchronization could be performed between any two or more devices from chiplet, to chips (e.g., servers and NIC), to networking equipment (e.g., switches, routers, appliances, etc.). For example, a ring that connects devices can include an external network switch, a network interface device, and server chiplets and a wireless connectivity chip in a server system. Use of a ring or other connections to perform time synchronization using pulses can be redundant to another synchronization method such as IEEE1588 and PTM.

In some examples, there could be multiple levels of rings that can be used for timing synchronization. For example, TOR switches in a data center could be synchronized on one ring whereas the TOR switch and network interface devices could be synchronized using a separate ring and network interface devices, server chips, and support circuit chips could be synchronized using a third ring. Use of a ring or other connections to perform time synchronization using pulses can be redundant to another synchronization method such as IEEE1588 and PTM.

In some examples, point-to-point or point-to-multipoint connections and a ring connection can be used for timing synchronization. For example, TOR switches in a data center could be synchronized on one ring whereas the TOR switch and network interface devices could be synchronized using a separate ring and network interface devices, server chips, and support circuit chips could be synchronized via a point-to-multi-point connection using a pulse per second. Such a point-to-multi-point connection could include one or more buffers to distribute the pulse per second or clock signal. For example, a network interface device could send a PPS signal across a PCIe connector to a server board, that is connected to a one input to multiple output buffers, where each outputs of an output buffer is sent to a server or support circuit chip. Similarly, a server chip could be source of a 1 PPS, and its output could be provided to a buffer and the output could be output to a network interface device and or other server or server support chips. Use of rings and point-to-point or multipoint connections to perform time synchronization using pulses can be redundant to another synchronization method such as IEEE1588 and PTM.

In some examples, wireless time synchronization could be used. For example, a TOR switch can be synchronized wirelessly (e.g., GPS or Ultra-Wideband (UWB) reference IEEE802.15.4-2011 or IEEE 802.15.4z-2020), and the TOR switch could then synchronize with network interface devices using a ring. Finally, the network interface devices could synchronize with point-to-multi-point 10 kHz synchronization clocks. Use of wireless time synchronization or point-to-multi-point 10 kHz synchronization clocks can be redundant to another synchronization method such as IEEE1588 and PTM.

FIGS. 2C-1 to 2C-3 depict examples of time stamp capture for edges of a control signal. For example, a TOR switch time clock can be used as a time source reference for other servers or appliances. FIG. 2C-1 depicts an example of signals generated by one or more of: network interface device 200, server 210-1, server 210-2, and server 210-N. For example, time stamp values can be generated based on clock signal CLK. Controller can generate a control signal CTL that indicates times that a bi-directional interface is to output pulses. For example, a CTL time value of 0 can cause a pulse output during a CLK time value of 0 whereas a CTL value of 1 can cause a pulse output during a CLK time value of 5.

FIG. 2C-2 depicts an example of time clock offsets between a switch and server 1 as (-) 2 ns (e.g., Server 1's time clock is 2 ns faster than a TOR switch's time clock), time clock offsets between the TOR switch's time clock and server 2 as 5 ns (e.g., Server 2's time clock is 5 ns faster that the TOR switch's time clock), and time clock offsets between the TOR switch's time clock and server 3 as 9 ns (e.g., Server 3's time clock is 9 ns faster than the TOR switch's time clock), Based on the error at the different servers, the clocks of those servers can be adjusted to match the TOR switch's time clock.

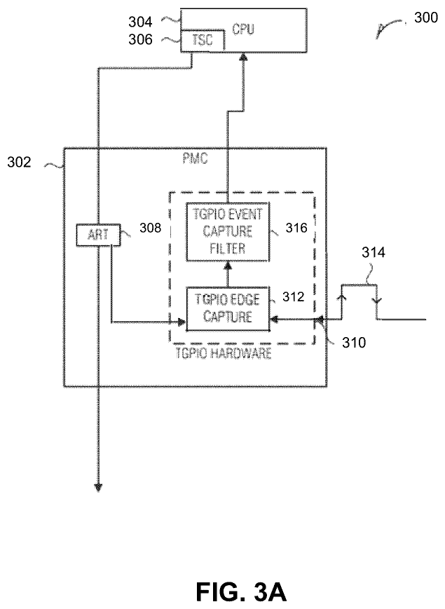

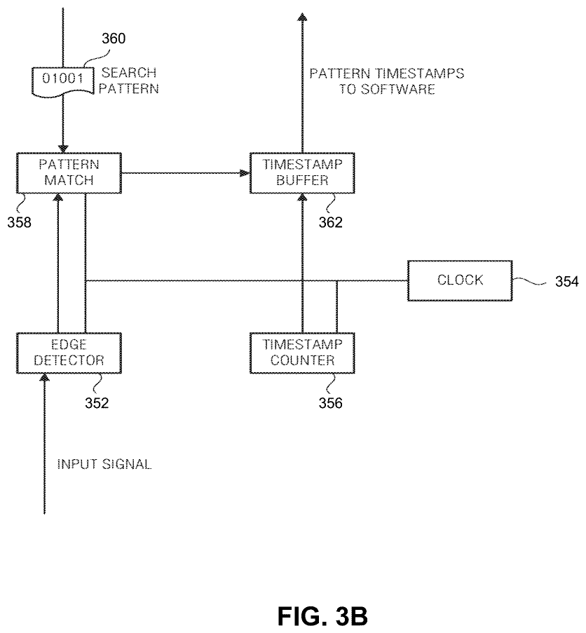

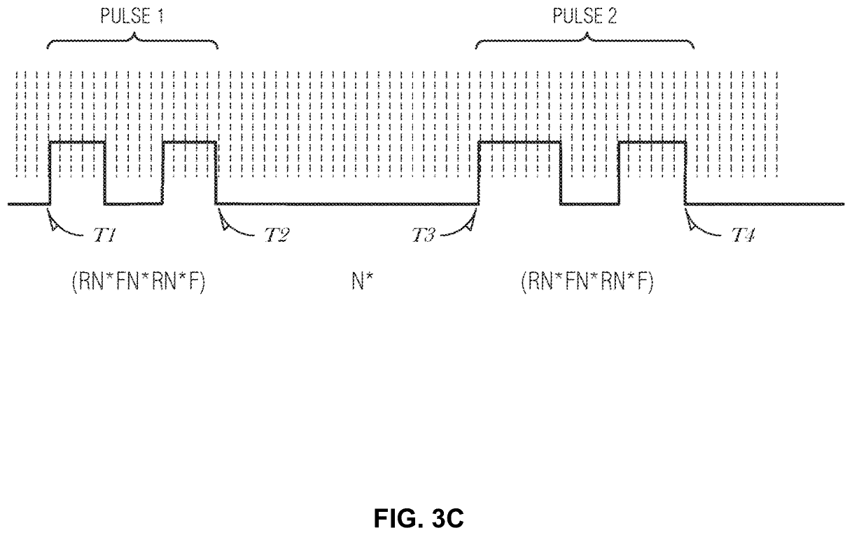

FIG. 2C-3 depicts an example of time clock offsets between devices with propagation delay considered in determining an amount of adjustment to a clock signal. Consideration of propagation delay can lead to additional timing signal offsets between the devices. The propagation delays can have jitter and this jitter can add up over the ring as well.

FIG. 3A depicts an example of a time-aware general-purpose input output (TGPIO) system 300. TGPIO system 300 may be included on a PCI mezzanine card (PMC) 302 that is configured to communicate with a CPU 304 over a PCI bus. CPU 304 can include a Time Stamp Counter (TSC) 306, based on a CPU clock signal. TSC 306 can be synchronized to an Always Running Timer (ART) 308 on the PMC 302. TSC 306 can be used for operating system level timekeeping.

PTM can be utilized for coordination of events across multiple components with independent time clocks. Coordination could be difficult given that individual time clocks have differing notions of the value and rate of change of time. PTM allows components to calculate the relationship between their local times and a shared PTM Master Time with an independent time domain associated with a PTM Root.

In some examples, PTM communications may be conducted between devices. A downstream device can include an upstream port through which the downstream device can send messages to an upstream device. The upstream device can include a downstream port through which the upstream device can send messages to a downstream device. The PTM communications can enable components with differing local time to calculate the relationship between their local times and a shared PTM Main Time (e.g., Time Stamp Counter (TSC)) associated with a PTM Root. The PTM Root is a PCIe Root Port that is the source of PTM Main Time for other devices, such as downstream device and upstream device.

TGPIO pin 310 on the TGPIO edge capture circuitry 312 can be used to receive an input signal 314 driven by an external device. TGPIO edge capture circuitry 312 may be designed, programmed, adapted, or otherwise configured to timestamp rising and falling edges (events) of a signal generated by an external device that is connected to the TGPIO input pin. The input signal may be periodic, for example, a GPS clock or aperiodic, for example, sensor input. Multiple TGPIO pins 310 may be used in TGPIO hardware. TGPIO edge capture circuitry 312 may be implemented for each TGPIO pin 310. Edges of input signal 314 can be timestamped using the ART clock 308 and the CPU can be notified of TGPIO events. An event can include: a rising edge, a falling edge, or sets of rising or falling edges of input signal 314.

TGPIO event capture filter circuitry 316 may be designed, programmed, adapted, or otherwise configured to search the events of the input signal for a pattern. TGPIO event capture filter circuitry 316 can identify patterns of timestamped events using an input pattern specification (e.g., search pattern). The input pattern specification may be, for example, regular expressions or fuzzy logic rules. When a pattern is recognized the TGPIO event capture filter circuitry 316 returns the timestamps that are of interest to an application. A filter specification provided by application software can specify events of interest. The search pattern may be provided by software executing on the CPU 304 to provide a software-configured filter.

FIG. 3B is a block diagram illustrating an architecture for implementing a time-aware general-purpose input output (TGPIO) system, according to an embodiment. An edge detector circuitry 352 may detect rising or falling edges of an input signal. The edge detector circuitry 352 outputs an indicator of a rising edge (R), a falling edge (F), or a no change (N) for each clock cycle. A device clock 354 is used to drive a timestamp counter 356.

As edge statuses are collected with the edge detector circuitry 352 and timestamps of each edge are stored in the timestamp buffer 362. Pattern match circuitry 358 may analyze the edges stored in the timestamp buffer 362 for a pattern. Search pattern 360 may be specified by software. When a pattern in the edges is detected, the timestamps for the related edges can be sent to a user application or other software (e.g., operating system).

In some examples, search pattern 360 can be in the form of a regular expression. In some examples, search pattern 360 can be in the form of fuzzy logic rules that are implemented at pattern match circuitry 358. Search pattern 360 may be implemented as a finite state automaton (FSA).

When a pattern is detected, the timestamp corresponding to the pattern obtained from timestamp counter 356 can be stored in a queue in timestamp buffer 362. The software may be alerted of the pattern's existence or the software may poll the timestamp buffer 362 to determine which patterns have been buffered.

FIG. 3C is a diagram illustrating a series of pulses in a signal, according to an embodiment. The pulses include a rising edge at time T1, a falling edge at time T2, a rising edge at time T3, and a falling edge at time T4. The diagram includes the clock ticks illustrated as vertical dashed lines. As can be observed, some of the periods of no change (either high or low signal) have different durations.

A search pattern can be provided in the form of a regular expression.

(RN*FN*RN*F)N*(RN*FN*RN*F)

where R is a rising edge, N is a no-change state, and F is a falling edge.

The parenthesis in the search pattern are used to denote timestamps of interest. Based on the regular expression, the search pattern is a rising edge followed by zero or more no-change states, followed by a falling edge, followed by zero or more no-change states, etc. A pattern of four pulses in the signal can match this example regular expression. Based on the parenthesis, the timestamps T1, T2, T3, and T4 are identified and stored when the pattern is matched. More specific ranges may be placed on the states to narrow the range of patterns that match.

Other examples of regular expressions include:
(RN{4}F)—this pattern can match a rising edge followed by four clock cycles of no-change states, then a falling edge;
(RN+F)—this pattern can match a rising edge followed by one or more no-change states, then a falling edge; and
(RN{3,6}F)—this pattern can match a rising edge followed by between three and six no-change states, then a falling edge.

Note these patterns could be programmable. Such programming could be performed by a local processor or remote processor or chiplet performing pattern generation. For a remote processor, a main time controller can be used that is aware of the timing and configuration. The main time controller could send programs, configurations, and corrections to state machine, microcontroller, or microprocessor that controls the Time-Aware GPIO. Such local or remote programming could use precise time instructions. These instructions could be instructions specifically designed to control the TGPIO, time aware instructions such as Intel's TPAUSE instruction, or a current microprocessor or GPU instruction such as a MOVE, Jump (or Branch), Abort (or Halt), Add, Multiply, etc., that has at least one time operand, where the time operand affect the execution of the instruction.

FIG. 4 depicts an example system. In some examples, chiplets 402-0 to 402-X (where X is an integer) can include circuitry to perform operations of a device interface (e.g., PCIe, UPI, CXL), compute or processing, memory, networking (e.g., Ethernet), storage, accelerator (e.g., FPGA), or others. Chiplets could include external chips or chiplets such physical layer interfaces (PHYs), server chiplets, network interface device chiplets, or memory modules. In some examples, chiplets 402-0 to 402-X can include circuitry to generate periodic pulse signals in a similar manner as that of network interface device 200 and server 210-1 to server 210-N and output the pulse signals to another chiplet using one of multiple paths. For example, chiplet 402-0 can generate and provide periodic pulse signals to chiplet 402-1. For example, a chiplet can utilize TGPIO pins to convey pulse timing signals. A chiplet can use circuitry described herein to generate pulse signals such as a microcontroller executing instructions, a state machine circuitry, and others.

Chiplet 402-1 can generate periodic pulse signals in a similar manner as that of network interface device 200 and server 210-1 to server 210-N. Chiplet 402-1 can synchronize the generated periodic pulse signals with received periodic pulse signals in a similar manner as that of network interface device 200 and server 210-1 to server 210-N.

In some examples, chiplets in a system on chip (SoC) can communicate timing signals using bi-directional interface interconnects that can at least send or receive timing signals using one or more inputs and one or more outputs. For example, a monitoring chiplet (e.g., Ethernet chiplet) can communicate with other chiplets via direct links or via multiple chiplet hops to determine if a chiplet or link is inoperable or unresponsive. To determine if a chiplet or link is inoperable or unresponsive, a monitoring chiplet could monitor incoming pulses from other chiplets and based on non-receipt of incoming pulses from another chiplet, determine to change a path of timing signals to change a link to such chiplet and avoid an inoperable or unresponsive link or connection.

During a first mode of operation, a chiplet can communicate timing signals to a neighboring chiplet in a clockwise direction using a first path. For example, chiplet 402-0 can generate and transmit pulse signals to compute chiplet 402-1. Compute chiplet 402-1 can determine an offset of the received pulse signals against pulse signals generated by compute chiplet 402-1. Compute chiplet 402-1 can adjust its clock signal based on the offset and potentially considering propagation delay of a transmission medium from chiplet 402-0 to compute chiplet 402-1. Similarly, compute chiplet 402-1 can generate and transmit pulse signals to memory chiplet 402-2. Similar operations can occur for other connected chiplets.

Based on a disruption in connection between chiplets, a second path can be utilized to provide transmission of timing signals between chiplets. For example, the second path can traverse chiplets in an opposite direction (e.g., counter-clockwise) than that of the first path. For example, based on a disruption of communication between compute chiplet 402-1 and memory chiplet 402-2, compute chiplet 402-1 can change to communicate pulse signals to memory chiplet 402-2 via the second path, which does not include the connection between compute chiplet 402-1 and memory chiplet 402-2.

Accordingly, chiplets in a single SOC device or multiple SOC devices can be communicatively coupled and provide timing signals via one or more alternate paths to synchronize timers among two or more chiplets. To provide built-in redundant paths, the first path can be a ring arrangement that connects chiplets and the second path could be a ring arrangement that connect chiplets. A number of chiplets that can synchronize timers can scale up or down.

In some cases, if a chiplet or server cannot be reached with pulse signal, the chiplet or server time domain can be considered unreliable and time stamp dependent operations may not be performed on that chiplet or server.

In some cases, utilizing a processor to execute instructions to generate waveforms can lead to the processor stalling and a generated waveform with transitions that are delayed. Offloading waveforms generation using circuitry can allow the processor to enter sleep mode and reduce power usage and potentially reduce carbon footprint and/or electrical expenses. In some examples, a processor can offload generation of time stamp values to a state machine or microcontroller that executes time-based instructions to generate time stamp values can cause output of a value 1 at a precise time X (e.g., nanoseconds, nanosecond fractions, picoseconds, or other intervals) and cause output of a value 0 at a precise time X+Y (e.g., nanoseconds, nanosecond fractions, picoseconds) to generate oscillating values that include pulses or are clock-like and to generate a defined value at a defined time with a pattern start time. The circuitry can be utilized by a bi-directional interface to generate time stamp values for 1 values generated by the circuitry. The circuitry can be programmed to generate more than one pattern. Bi-directional interface output can be forced to a 1, 0, high-Z, weak pull up/down, etcetera at a precise time. Bi-directional interface can operate as an input during a first mode time and an output during a second mode.

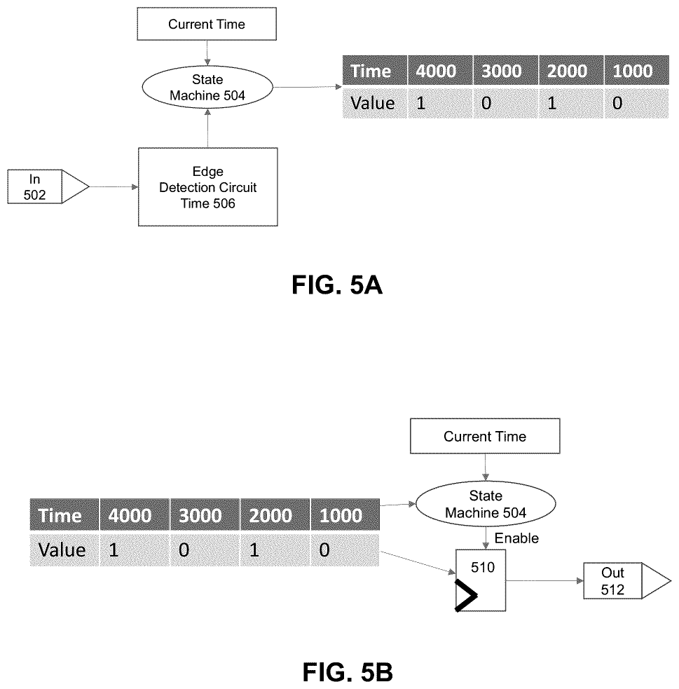

FIG. 5A depicts an example system to generate timing signals using a circuitry configured to perform a state machine that is to perform edge detection and output time stamp values. The system of FIG. 5A can be coupled to one or more bi-directional interfaces, such as a TGPIO. An input circuitry (In) 502 can receive a clock signal from a timing source, where the clock signal can be based on a network source, GPS, and or other sources. Edge detection circuit time 506 can detect the rising or falling edge of a signal or a pattern of rising and falling edges and output a signal to indicate to state machine 504 to record a precise time of one or more edges. Current time can provide a current time stamp value and can be based on IEEE1588-2019, NTP, PPS, GPS, and or other clocking source.

FIG. 5B depicts an example output system. The system of FIG. 5B can be coupled to one or more bi-directional interfaces, such as a TGPIO. State machine 504 can monitor current time and the times output pin 512 is to change. When the current time matches the next time the output is to change (e.g., 4000, 3000, 2000, and 1000), state machine 504 can enable flip-flop 510 to accept the change at that time and generate an output corresponding to the value. Note that the circuit could compensate for output delays by choosing a current time that would allow it to match that delay. For example, if the output delay is X and the time the flop is to be enabled is Y, then when the current time equals Y-X, state machine 504 can start transfer to flip-flop 510.

Note that in some cases, the time detected by the state machine 504, processor 620 or 660, or microcontroller 600 may not align to the precision of the current time and a transfer of a time value could occur after the programmed time. For example, state machine 504 is to load a value of 1 at time 2000 into flip-flop 510 after a load of time of 0 at 1000 but clock circuitry could be counting time based on odd numbers, hence 1997, then 1999, and then 2001 and time 2000 was never detected. In such a case, the state machine could move the value 1 to the register at time 2001, as it is the first number after 2000. Other circuitry could be used to support the state machine such that output is loaded at precisely 2000. Such circuitry could include one or more of phase locked loops (PLLs), delay locked loops (DLL), delay lines, falling edge flops, etc.

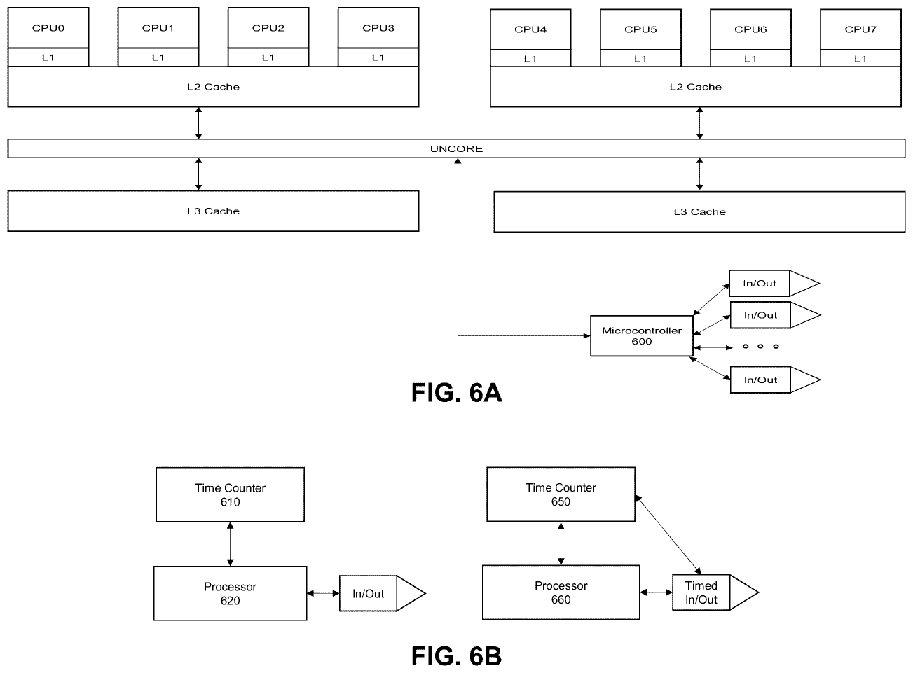

FIG. 6A depicts an example of microcontroller that communicates with one or more CPU clusters. One or more of CPU clusters, CPU0 to CPU7, can issue one or more instructions to microcontroller. A CPU can offload to the microcontroller one or more of: sampling of outputs at particular times, sample and validate waveforms at particular time stamp values, monitor input signals at particular time stamp values, or create transitions on an IO while the processor is in a sleep mode. Microcontroller 600 can control operation of one or more bi-directional interfaces at one or more particular time stamp values from time counter 610. Based on execution of one or more instructions, microcontroller 600 can: cause output of a value from a bi-directional interface at one or more particular times or sample a value at the bi-directional interface at a particular time to monitor incoming times of edge transitions (e.g., rising or falling edges) of received signals patterns. In some examples, the incoming pattern is a pulse per second, a 10 KHz clock, or includes a high-Z state.

Microcontroller 600 could receive programming using an application program interface (API) or configuration file. Such API could indicate output values at particular times. For example, the API could indicate on second intervals, set the output high, and after 500 millisecond intervals after going high, set the output to low. Likewise, the API specify an output pattern, where the pattern include a sequence of high and low values and associated event times or relative times. Relative times could be based off of a reference time. For example, every 1 second+0.00 ns output 1, then 500 ms later, output 0.

FIG. 6B depicts example processors that can execute instructions to control a value output from the input/output based on counter values. The processors can execute instructions issued by a CPU's operating system (OS) to generate time stamp values based on arrival times of edges. For example, processor 620 can change the value of the TGPIO output based on values specified by the instructions for particular time stamp values. At an input, the TGPIO can identify the rising edges or falling edges and pass that information to processor 620 and processor 660 can capture the current value of the precise time counter as the arrival time of rising edges or falling edges.

Processor 660 can indicate to TGPIO when to change output value based on values specified by the instructions for particular time stamp values. The TGPIO can identify a rising edge or falling edge and pass that information and the current value of time counter 650 (e.g., the arrival time) to processor 660 to capture the current value of the precise time counter as the arrival time of rising edges or falling edges.

In some examples, programming of the microcontroller or processor can be managed by a remote system (e.g., a data center time manager, a GPS Grand Master, an event manager appliance, etc.) and the remote system can send the program to the microcontroller or processor. The instructions sent by the remote system can include at least one instruction to cause generation of an output value at particular time stamp values. The microcontroller or processor can send status and failure notices to the remote system. A time source of time stamp values can include one or more of: a PPS grandmaster, an IEEE1588 source, or PTM source.

Some examples include processor-executed instructions that has at least one operand as a time. The time can be a subset of a global time, a precise time, or a relative time to repeat a series of instructions. Processor can create a pulse per second, where the relative time repeats the instructions ever second. A number of operands containing time can be one so that only one time is considered when executing the instruction. The instruction can execute before that time [MOVEBFR A B T to move A to B] if this instruction occurs before time T or after the time [MOVAFT A B T, move A to B only after time T]. In the case of an after type instruction (e.g., “move after”), time acts as a fence and does not allow out of order instructions after the time in the instruction. In the case of a “before” type instruction (e.g., “move before”), the instruction can be skipped if the time does not match the before/after case. The time can represent an expected time for execution of the instruction. If the expected time of execution is not met, a checkpoint operation can occur. The checkpoint operation can stop further processing, send other tasks to another processor or microcontroller to help meet the expected and or required performance. If a number of operands including time is two, the instruction executes between the two times or never executes between the two times. The time instruction can control an I/O pin, where the I/O Pin is time-aware, the I/O pin is an output, or the I/O pin can be placed in a Hi-Z state and turn into an input pin.

For precise time instruction checkpointing, a program is executed at a set time. However, if checkpoints are missed, then exceptions could be executed, with the expectation to put the program back on schedule. This exception could reduce the amount of work to generate timing pulses. For example, an image processing operation may involve 5 looped operations of a processing core. However, if time is not met at the checkpoint, processing 4 looped operations can achieve 99% of the quality and that quality level might be more acceptable than losing a frame. In such a case, a precise time instruction could verify that the processor using the checkpoint in the instruction is likely to complete the last loop of instructions. However if it is not likely to meet that time, a jump can occur to start processing a next video frame. An example could be a “Jump Before” instruction that could jump to the 5th loop or 5th set of instructions if the instruction occurred before a precise time (e.g., JMPBEF <jump label><time>).

In another example, processing a set of operations deterministically (e.g., main job) has priority over performance of other jobs. If a check point time is not met or not within a tolerance for the main job, more processing resources could be added to complete this set of operations, such as by reducing load on neighboring devices, allocation more cache resources to the deterministic job, re-allocating execution of subroutines to other processing elements, or increasing frequency of operation of a processor or circuitry that executes the main job. However, if a check point is arrived at very late, a skip to a next frame can occur. A “call if between” instruction could be executed to increase resources available to the main routine and a “call if after” could be executed to abort processing of the current frame and move to a next frame. A compound time checkpoint instruction with pointers to functions could be executed for conditions of: early, running late or too late. For example, resources can be slowed down or freed if a checkpoint is reached early, more resources could be allocated if a checkpoint is met late, or skip to a next frame if a checkpoint is reached too late.

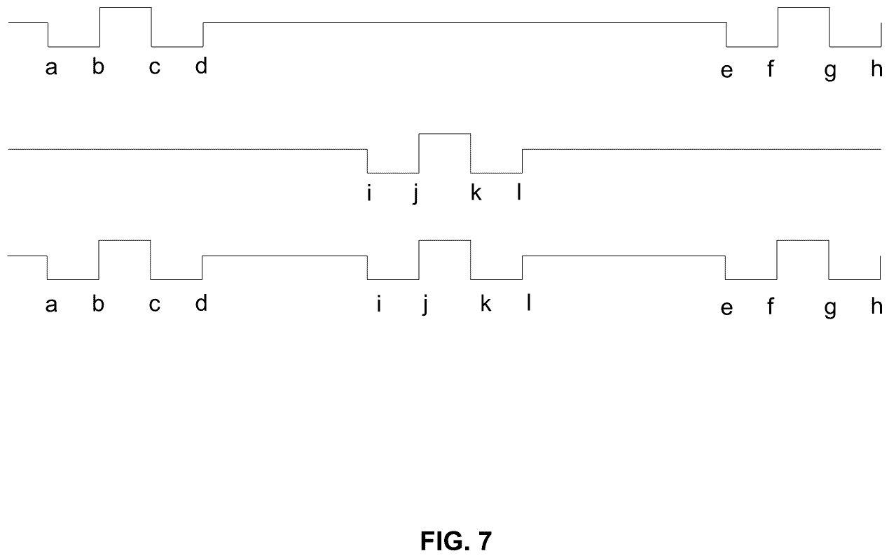

FIG. 7 depicts an example of instruction execution to sample a received signal at a bi-directional interface. Three devices can output to a shared line. Instead of a ring, a single wire can be communicatively couple devices to one another. For example, two servers could drive a value at a certain time, and a third server could receive the signals from the other two servers to synchronize with time of the system. Three servers could receive signals from the same medium (e.g., signal on a wire) to determine when the other devices are synchronized.

For example, the instruction for precise time “a” could be: MOV 0 PIN A, which can produce a value of zero on the I/O Pin at or after time A. For “b”: an instruction MOV 1 PIN B can produce a value of 1 on the I/O Pin at or after time B. Note that a jump instruction could occur at a particular time before time “a” to execute a routine of precise time instructions.

A first processor can execute instructions to cause a signal to: drive low at time a, drive high at time b, drive low at time c, drive high-Z at time d, drive low at time e, drive high at time f, drive low at time g, drive high-Z at time h.

A second processor can execute instructions to cause a signal to: drive low at time i, drive high at time j, drive low at time k, drive high-Z at time 1.

A third processor can execute instructions to cause sample waveforms generated by first and second processors and examine rising edges. For example, third processor could record times b, j, and f and compare the times to expected times for b, j, and f and make corrections to better align their precision.

In some examples, instructions can include current and instructions for servers/CPUs, GPU, tensor processing units (TPUs), digital signal processors (DSP), microcontrollers, video coding units (VCUs), vision processing units (VPUs), network processing units (NPUs), infrastructure processing units (IPUs), compression engines, encryption engines, and other common processing elements. For example, precise time instructions could be added to Intel® AVX-512 instructions to cause the instructions to be executed at specific times. For example, instructions can cause sampling or generation of values at particular times. For example, AVX-512_VBMI, AVX-512_VBMI2, AVX-512_BITALG, AVX-512_IFMA, or AVX-512_VAES provide Vector Byte Manipulation Instructions, which include mathematical operations, permutes and shifts. For example, one or more instructions in the Table 1 below can be executed at, before, after, or between a precise time. Likewise, a checkpoint time could be added to an instruction to confirm that the instruction is performed in a deterministic fashion or within a deterministic time. If the instruction is not performed within that time, an exception could occur that offloads processing to other processing element or it could change the processing sequence.

An example of a precise time checkpointing instruction could be:

MOVCHK A B<time>

This instruction would move the contents of register A to register B and if it did not occur by the precise time, a checkpoint exception would occur. Note the checkpointing could be combined with a before, after or between instruction. For example, an instruction can be:

MOVBETCHK A B<start time><end time>

In this case if the time is between the start time and end time, then the contents of register A moves to register B. However, if outside that time, an exception could occur. Another implementation could specify that the exception are to occur only if the exceptions occur after the end time.

TABLE 1

| Instruction | Execution |
|---|---|
| VPERMB | Cause 64-byte any-to-any shuffle, 3 clocks, |
| | 1 per clock. |
| VPERMI2B | 128-byte any-to-any overwriting indexes, 5 |
| | clocks, 1 per 2 clocks. |
| VPERMT2B | 128-byte any-to-any overwriting tables, 5 |
| | clocks, 1 per 2 clocks. |
| VPMULTISHIFTQB | Base64 conversion, 3 clocks, 1 per clock. |
| VPCOMPRESSB | Store sparse packed byte integer values into |
| | memory or register. |
| VPCOMPRESSW | Store sparse packed word integer values into |
| | memory or register. |
| VPEXPANDB | Load sparse packed byte integer values from |
| | memory or register. |
| VPEXPANDW | Load sparse packed word integer values from |
| | memory or register. |
| VPSHLD | Concatenate and shift packed data left logical. |
| VPSHRD | Concatenate and shift packed data right logical. |
| VPSHLDV | Concatenate and variable shift packed data left |
| | logical. |
| VPSHRDV | Concatenate and variable shift packed data right |
| | logical. |
| VPOPCNTB | Return the number of bits set to 1 in a byte. |
| VPOPCNTW | Return the number of bits set to 1 in a word. |
| VPSHUFBITQMB | Shuffles bits from quadword elements using byte |
| | indexes into mask. |
| VPMADD52LUQ | Packed multiply of unsigned 52-bit integers and |
| | add the low 52-bit products to qword accumula- |
| | tors. |
| VPMADD52HUQ | Packed multiply of unsigned 52-bit integers and |
| | add the high 52-bit products to 64-bit accumula- |
| | tors. |

Additionally, one or more time operands could be added to any current instruction for a microprocessor, Graphics Processing Unit, Vector Processing Unit, AI/ML/Tensor processor, digital signal processor (DSP), etc. These time operands can dictate behavior before, after, or between the time operand or operands. These time operands can act as a fence to limit out of order operation. These time operands could be used as a checkpoint to enable additional resources when a program is running behind. Precise time instructions could increase the determinism of the code that is being executed.

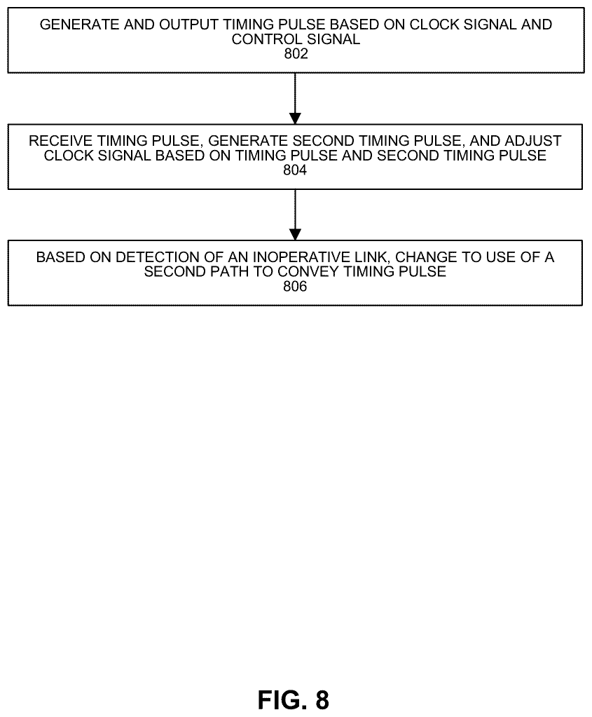

FIG. 8 depicts an example process. The process can be performed by a platform (e.g., network interface device, host server, and/or process executed by a processor). At 802, a platform can generate a timing pulse signal based on a clock signal and control signal. The control signal can indicate times at which to output a pulse in the timing pulse signal. At 802, the platform can output the timing pulse signal to a second platform via a bi-directional interface using a first path. At 804, the second platform can generate a timing pulse signal and adjust its time clock signal based on the generated timing pulse signal and the received timing pulse signal. For example, the timing pulse signal can be generated in a similar manner to that of the platform. At 806, based on detection of an inoperative link, the second platform can adjust its bi-directional interface to generate and output a timing pulse signal to the platform using a second path. The second path can exclude the inoperative link and provide a different route to the platform.

FIG. 9 depicts an example computing system. System 900 can be used to program network interface device 950 or other circuitry (e.g., processors 910 or a process executed thereon) to perform select from paths to convey timing pulse signals for clock synchronization, as described herein. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die.

Accelerators 942 can be a fixed function or programmable offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 942 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, a driver (e.g., Linux® driver or OS driver such as Linux® ptp41) can configure and/or offload to network interface 950 to select from paths to convey timing pulse signals for clock synchronization, as described herein. The OS and driver can enable or disable capability of network interface 950 to select from paths to convey timing pulse signals for clock synchronization, as described herein.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include a physical layer interface (PHY), media access control (MAC) decoder and encoder circuitry, an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory.

Some examples of network interface 950 are part of an Infrastructure Processing Unit (IPU) or data processing unit (DPU) or utilized by an IPU or DPU. An xPU can refer at least to an IPU, DPU, GPU, general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

In an example, system 900 can be implemented using interconnected compute sleds of processors, memories, storages, network interfaces, and other components. High speed interconnects can be used that are consistent with at least one or more of the following: Ethernet (IEEE 802.3), remote direct memory access (RDMA), InfiniB and, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

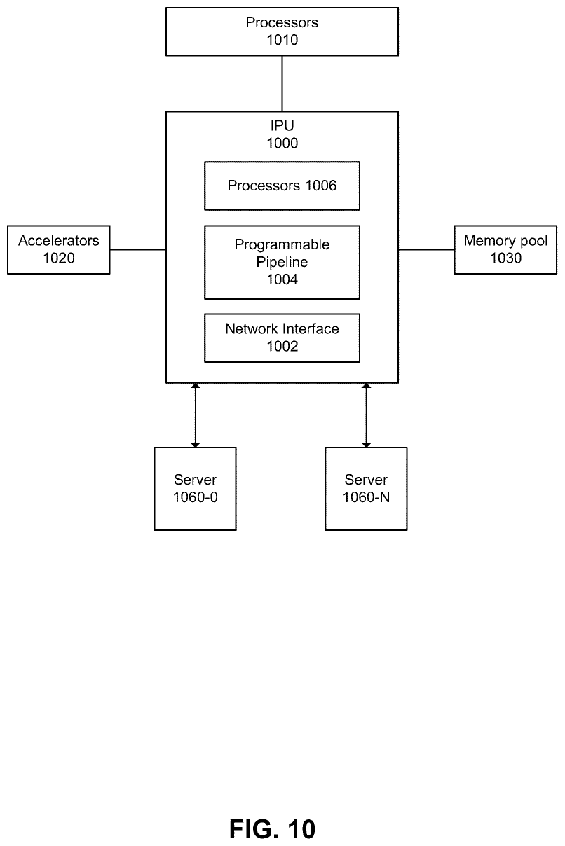

FIG. 10 depicts an example system. Devices and software of an infrastructure processing unit (IPU) system 1000 can perform select from paths to convey timing pulse signals for clock synchronization, as described herein. In this system, system 1000 manages performance of one or more processes using one or more of processors 1006, processors 1010, accelerators 1020, memory pool 1030, or servers 1060-0 to 1060-N, where N is an integer of 1 or more. In some examples, processors 1006 of IPU 1000 can execute one or more processes, applications, VMs, containers, microservices, and so forth that request performance of workloads by one or more of: processors 1010, accelerators 1020, memory pool 1030, and/or servers 1060-0 to 1060-N. IPU 1000 can utilize network interface 1002 or one or more device interfaces to communicate with processors 1010, accelerators 1020, memory pool 1030, and/or servers 1060-0 to 1060-N. IPU 1000 can utilize programmable pipeline 1004 to process packets that are to be transmitted from network interface 1002 or packets received from network interface 1002.

In some examples, devices and software of IPU 1000 can perform capabilities of a router, load balancer, firewall, TCP/reliable transport, service mesh, data-transformation, authentication, security infrastructure services, telemetry measurement, event logging, initiating and managing data flows, data placement, or job scheduling of resources on an XPU, storage, memory, or central processing unit (CPU).

In some examples, devices and software of IPU 1000 can perform operations that include data parallelization tasks, platform and device management, distributed inter-node and intra-node telemetry, tracing, logging and monitoring, quality of service (QoS) enforcement, service mesh, data processing including serialization and deserialization, transformation including size and format conversion, range validation, access policy enforcement, or distributed inter-node and intra-node security. IPU 1000 could be part of a ring of connected device and could connect a timing signal between IPU 1000 and one or more processors in a ring configuration. IPU 1000 could represent a server's time by sending the timing signal, or adjust time based off the timing signal with other devices in the rack or data center.

Programmable pipeline 1004 can include one or more packet processing pipeline that can be configured to perform match-action on received packets to identify packet processing rules and next hops using information stored in a ternary content-addressable memory (TCAM) tables or exact match tables in some embodiments. Programmable pipeline 1004 can include one or more circuitries that perform match-action operations in a pipelined or serial manner that are configured based on a programmable pipeline language instruction set. Processors, FPGAs, other specialized processors, controllers, devices, and/or circuits can be utilized for packet processing or packet modification. For example, match-action tables or circuitry can be used whereby a hash of a portion of a packet is used as an index to find an entry. Programmable pipeline 1004 can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of programmable pipeline 1004, including its data plane, can be programmed based on one or more of: one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), eBPF, x86 compatible executable binaries or other executable binaries, or others.

Programmable pipeline 1004 and/or processors 1006 can perform select from paths to convey timing pulse signals for clock synchronization, as described herein.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

Illustrative examples of the devices, systems, and methods disclosed herein are provided below. An embodiment of the devices, systems, and methods may include any one or more, and any combination of, the examples described below.

Some examples include devices that communicate precise time over two bi-directional interfaces, setup as an egress interface and an ingress interface where each device has the bi-directional interface and can communicate precise time in a loop or ring during normal operation, or as a point-to-point interface during abnormal/fault conditions, with a precise time source.

Some examples include a system of devices that communicate precise time over two bi-directional interfaces, setup as an egress interface and an ingress interface where each device has the bi-directional interface and can communicate precise time in a loop or ring during normal operation, or as a point-to-point interface during abnormal/fault conditions, with a precise time source. In some examples, the bi-directional interface can be implemented by a time-aware general purpose interface (TGPIO). In some examples, the TGPIO can generate a timing pattern with transitions occurring at particular time intervals. In some examples, the pattern comprises one or more of: a one pulse per second, a repeating clock (10 kHz), the generation of a high Z output. In some examples, the pattern is generated using a microcontroller or state machine.

In some examples, the microcontroller executes a precise time instruction. In some examples, the precise time instruction moves a value to IO at a precise time. In some examples, the precise time instruction waits for a precise time to execute. In some examples, the precise time instruction is executed based on a time. In some examples, the precise time instruction is skipped based on a time. In some examples, the precise time is used by the system to understand if the program would complete on time (e.g., checkpoint). The completion time could then be used to add additional resources to make the system time-based operations more deterministic. For example, if the system is behind based on expected completion time, the frequency of the processing could be increase, neighboring cores could reduce, cache allocations could be adjusted, resource priorities could be raised, more bandwidth could be allocated, etc.

To change an input to output or output to input, the bi-directional interface can be flipped. The bi-directional interface can be tri-stated to communicate in multiple directions, where the multiple directions can be between two TGPIO pins and the multiple direction is two or more.

Other information can be passed between devices besides precise time, such as position in the ring, power/management details, and timing information.

Some examples can synchronize to a particular time source and verify quality of the time source, such as the device that is being synchronized or quality of the synchronization. In a data center, verification can be performed by devices connected using a ring. The ring can connect network interfaces devices and servers. A redundant or secondary path used for verification can be used to synchronize the devices in the case of a failure in a primary synchronization method (such as IEEE1588-2019). The verification of time domain accuracy can allow confirmation of a service level agreement (SLA) or service level objective (SLO) is met. These agreement or objection may be part of binding contract with customer that time must be trusted within a certain accuracy. Verification of precise time can be communicated to an application, where the application includes a database, a real-time application (e.g., real time content generation, advertisement generation, etc.) or time-aware application that would fail or have errors if precise time specification are not met.

Some examples include a timecard (e.g., IEEE P3335™, Standard for Architecture and Interfaces for Time Card) that has at least one pin that is used to communicate timing signals to verify time precision communicated by a network based time source (e.g., IEEE1588, PTM, NTP, SYNC-E, Data-Plane Time (DPTP), PPS, 10 KHz Clock, 10 MHz clock, wireless Ultrawideband, and so forth. At least one pin of a network interface device, CPU, server, a support chip, or chiplet such as a Platform Controller Hub (PCH) can be connected to a Time Aware GPIO. Time Aware GPIO can create a signal at a particular time. Time-Aware GPIO can record the time of the arrival of a signal transition. Operations of a Time Aware GPIO can be controlled using a precise time instruction in a microcontroller.

Some examples include: in a group of processing elements: the processing elements attempting to perform a timing operation such as timing synchronization based on a first group of timing operations sent via a first path, where the first group comprises a first connection and based on a second path of time synchronization by the first connection between processing element in the group of processing elements, the processing elements attempting to perform timing synchronization based on a second group of timing information sent via the second path, where the second path does not traverse the first connection and a difference between the paths indicates the time is within a desired range of synchronization.

Example 1 includes one or more examples and includes a method comprising: in a group of servers: the servers attempting to perform timing synchronization based on a first group of timing signals sent via a first path, wherein the first comprises a first connection and based on disruption of communications by the first connection between servers in the group of servers, the servers attempting to perform timing synchronization based on a second group of timing signals sent via a second path, wherein the second path does not traverse the first connection.

Example 2 includes one or more examples and includes a central processing unit (CPU) offloading generation of a timing signal of the first group of timing signals to a microcontroller.

Example 3 includes one or more examples, wherein the first connection comprises communication via a first bi-directional interface and a second bi-directional interface.

Example 4 includes one or more examples, wherein communication via the second path comprises: adjusting the first bi-directional interface and the second bi-directional interface to output timing signals via the second path.

Example 5 includes one or more examples, wherein the first group of timing signals comprises a first group of pulses generated based on processor-executed instructions and a network timing source and the second group of timing signals comprises a second group of pulses generated based on processor-executed instructions and a network timing source.

Example 6 includes one or more examples, wherein the servers attempting to perform timing synchronization based on a first group of timing signals sent via a first path comprises a server of the servers generating a timing signal of the first group of timing signals and adjusting a clock signal based on the generated timing signal and a second timing signal of the first group of timing signals.

Example 7 includes one or more examples, wherein: the first group of timing signals comprises at least one pulse per second (PPS) signal and the second group of timing signals comprises at least one PPS signal.

Example 8 includes one or more examples, and includes an apparatus that includes: a network interface device comprising: circuitry to generate timing signals based on timestamps for respective edges of a clock signal and circuitry comprising a set of at least one input interface and at least one output interface, wherein: during a first mode of operation, the at least one output interface is to provide the timing signals to a first device to cause the device to synchronize with the timing signals and based on an indication to select a second mode of operation associated with a communication path with an inoperative link, the at least one output interface is to provide the timing signals to a second device to cause the second device to synchronize with the timing signals.

Example 9 includes one or more examples, wherein: the first mode of operation comprises a first path that communicates a set of timing signals including the timing signals by traversal of one or more devices, the second mode of operation comprises a second path that communicates a set of timing signals including the timing signals by traversal of one or more devices, and the second path does not traverse the inoperative link.

Example 10 includes one or more examples, wherein the circuitry to generate timing signals based on timestamps for respective edges of a clock signal is to: during the first mode of operation, adjust the clock signal based on the generated timing signals and a timing signal received at the at least one input interface.

Example 11 includes one or more examples, wherein the circuitry to generate timing signals based on timestamps for respective edges of a clock signal comprises a processor to execute instructions to generate the timing signals.

Example 12 includes one or more examples, wherein the clock signal is based on a network timing source and the timing signals comprise a periodic pulse signal.

Example 13 includes one or more examples, and includes a rack of servers, wherein the first device comprises a first server of the rack of servers, the second device comprises a second server of the rack of servers, and the network interface device is communicatively coupled to the first and second servers.

Example 14 includes one or more examples, and includes at least one non-transitory computer-readable medium comprising instructions stored thereon, that if executed, cause one or more processors to: configure circuitry of a network interface device to: generate timing signals; during a first mode of operation, cause at least one output interface to provide timing signals to a first device, wherein the first device is to adjust an associated clock signal based on the timing signals; and based on an indication to select a second mode of operation associated with a communication path with an inoperative link, cause at least one output interface to provide the timing signals to a second device, wherein the second device is to adjust an associated clock signal based on the timing signals.

Example 15 includes one or more examples, wherein the first mode of operation comprises a first path that communicates a set of timing signals including the timing signals by traversal of one or more devices, the second mode of operation comprises a second path that communicates a set of timing signals including the timing signals by traversal of one or more devices, and the second path does not traverse the inoperative link.

Example 16 includes one or more examples, and includes instructions stored thereon, that if executed, cause one or more processors to: during the first mode of operation, cause adjustment of a clock signal based on the generated timing signals and a timing signal received at an input interface.

Example 17 includes one or more examples, wherein the generate timing signals is based on processor-executed instructions to generate the timing signals.

Example 18 includes one or more examples, wherein the timing signals comprise a periodic pulse signal and the timing signals are based on a network timing source.

Example 19 includes one or more examples, wherein communication based on the second mode of operation comprises causing a bi-directional interface to output the timing signals to the second device.

Example 20 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).

What is claimed is:

1. A method comprising:
in a group of servers:
the servers attempting to perform timing synchronization based on a first group of timing signals sent via a first path, wherein the first comprises a first connection and
based on disruption of communications by the first connection between servers in the group of servers, the servers attempting to perform timing synchronization based on a second group of timing signals sent via a second path, wherein the second path does not traverse the first connection.

2. The method of claim 1, comprising:
a central processing unit (CPU) offloading generation of a timing signal of the first group of timing signals to a microcontroller.

3. The method of claim 1, wherein the first connection comprises communication via a first bi-directional interface and a second bi-directional interface.

4. The method of claim 3, wherein communication via the second path comprises:
adjusting the first bi-directional interface and the second bi-directional interface to output timing signals via the second path.

5. The method of claim 1, wherein
the first group of timing signals comprises a first group of pulses generated based on processor-executed instructions and a network timing source and
the second group of timing signals comprises a second group of pulses generated based on processor-executed instructions and a network timing source.

6. The method of claim 1, wherein the servers attempting to perform timing synchronization based on a first group of timing signals sent via a first path comprises a server of the servers generating a timing signal of the first group of timing signals and adjusting a clock signal based on the generated timing signal and a second timing signal of the first group of timing signals.

7. The method of claim 1, wherein:
the first group of timing signals comprises at least one pulse per second (PPS) signal and
the second group of timing signals comprises at least one PPS signal.

8. An apparatus comprising:
a network interface device comprising:
circuitry to generate timing signals based on timestamps for respective edges of a clock signal and
circuitry comprising a set of at least one input interface and at least one output interface, wherein:
during a first mode of operation, the at least one output interface is to provide the timing signals to a first device to cause the device to synchronize with the timing signals and
based on an indication to select a second mode of operation associated with a communication path with an inoperative link, the at least one output interface is to provide the timing signals to a second device to cause the second device to synchronize with the timing signals.

9. The apparatus of claim 8, wherein:
the first mode of operation comprises a first path that communicates a set of timing signals including the timing signals by traversal of one or more devices,
the second mode of operation comprises a second path that communicates a set of timing signals including the timing signals by traversal of one or more devices, and
the second path does not traverse the inoperative link.

10. The apparatus of claim 8, wherein the circuitry to generate timing signals based on timestamps for respective edges of a clock signal is to:
during the first mode of operation, adjust the clock signal based on the generated timing signals and a timing signal received at the at least one input interface.

11. The apparatus of claim 8, wherein the circuitry to generate timing signals based on timestamps for respective edges of a clock signal comprises a processor to execute instructions to generate the timing signals.

12. The apparatus of claim 8, wherein the clock signal is based on a network timing source and the timing signals comprise a periodic pulse signal.

13. The apparatus of claim 8, comprising a rack of servers, wherein
the first device comprises a first server of the rack of servers,
the second device comprises a second server of the rack of servers, and
the network interface device is communicatively coupled to the first and second servers.

14. At least one non-transitory computer-readable medium comprising instructions stored thereon, that if executed, cause one or more processors to:
configure circuitry of a network interface device to:
generate timing signals;
during a first mode of operation, cause at least one output interface to provide timing signals to a first device, wherein the first device is to adjust an associated clock signal based on the timing signals; and
based on an indication to select a second mode of operation associated with a communication path with an inoperative link, cause at least one output interface to provide the timing signals to a second device, wherein the second device is to adjust an associated clock signal based on the timing signals.

15. The at least one non-transitory computer-readable medium of claim 14, wherein
the first mode of operation comprises a first path that communicates a set of timing signals including the timing signals by traversal of one or more devices,
the second mode of operation comprises a second path that communicates a set of timing signals including the timing signals by traversal of one or more devices, and
the second path does not traverse the inoperative link.

16. The at least one non-transitory computer-readable medium of claim 14, comprising instructions stored thereon, that if executed, cause one or more processors to:
during the first mode of operation, cause adjustment of a clock signal based on the generated timing signals and a timing signal received at an input interface.

17. The at least one non-transitory computer-readable medium of claim 14, wherein the generate timing signals is based on processor-executed instructions to generate the timing signals.

18. The at least one non-transitory computer-readable medium of claim 14, wherein the timing signals comprise a periodic pulse signal and the timing signals are based on a network timing source.

19. The at least one non-transitory computer-readable medium of claim 14, wherein communication based on the second mode of operation comprises causing a bi-directional interface to output the timing signals to the second device.

20. The at least one non-transitory computer-readable medium of claim 14, wherein the network interface device comprises one or more of: a network interface controller (NIC), a remote direct memory access (RDMA)-enabled NIC, SmartNIC, router, switch, forwarding element, infrastructure processing unit (IPU), or data processing unit (DPU).
